(19) United States
(12) Patent Application Publication
(10) Pub. No.: US 2018/0207836 A1
(43) Pub. Date: Jul. 26, 2018

(54) FLAIL CHAIN LINK WITH POLYGONAL CROSS-SECTION

(71) Applicant: Astec Industries, Inc., Chattanooga, TN (US)

(72) Inventor: Arnold Neil Peterson, Eugene, OR (US)

(73) Assignee: Astec Industries, Inc., Chattanooga, TN (US)

(21) Appl. No.: 15/468,327

(22) Filed: Mar. 24, 2017

Related U.S. Application Data
(60) Provisional application No. 62/449,166, filed on Jan. 23, 2017.

(51) Int. Cl. B27L 1/12

(52) U.S. Cl. CPC B27L 1/122; B27L 11/02

(57) ABSTRACT

A flail assembly for a debarking machine includes a flail shaft that is adapted to be rotated about a flail axis of rotation. Attached to the flail shaft is a flail chain that includes a plurality of interconnected links, at least some of which have a polygonal cross-section.

### CROSS-REFERENCE TO RELATED APPLICATION

This application claims the benefit of U.S. Provisional Patent Application No. 62/449,166 which was filed on Jan. 23, 2017.

### FIELD OF THE INVENTION

The present invention relates generally to devices and methods for removing the bark and small limbs from logs, and more particularly, to a flail chain for a flail assembly of a debarking machine. At least some of the chain links of the flail chain have a polygonal cross-section.

### BACKGROUND OF THE INVENTION

In processing logs for various purposes, it is usually necessary to first remove the bark and limbs from the logs. Debarking machines are known for this purpose, and frequently include flail assemblies comprising two or more rotating flail shafts to which are attached multiple flail chains. If the logs are intended to be processed into chips, it is common for a debarking machine to be located adjacent to, to be attached to, or to be combined with a log chipping machine. Furthermore, it is desirable to completely remove all bark prior to the chipping process, because bark is considered to be a contaminant in the chips.

In a debarking machine, logs are introduced into the rotating flail chains in a direction normal to the axis of rotation of the flail shaft. Typically, a plurality of flail shafts are arranged in a debarking machine so that at least one is an upper flail shaft and another is a lower flail shaft, although they may be laterally offset from each other. In such a machine, the processing direction along which the logs are passed through the machine is located between an upper flail shaft and a lower flail shaft. In order to remove the bark and limbs from the log, at least some of the flail chains on the upper flail shaft must reach down along the sides of the log to at least the mid-point. Similarly, at least some of the flail chains on the lower flail shaft must reach upwardly along the sides of the log to approximately the mid-point. Flail chains may be approximately sixteen inches long or longer, and are mounted close together. During the debarking operation, the flail chains are subjected to significant stresses.

FIG. 1 illustrates a portion of a conventional debarking machine 10 which includes upper flail assembly 12 and lower flail assembly 14. Each flail assembly includes a rotatable flail shaft comprising axle 16 to which a drum 18 is mounted. A plurality of conventional flail chains 19, each of which has an attachment end 20 and a free end 21, are operatively attached at the attachment end to each drum of the flail shaft, and the flail shafts are rotated so that the flail chains contact a log, such as log 22, that is moving in processing direction “P” into contact with the flail assemblies. Upper flail assembly 12 includes pivot arm 24 that is mounted to machine 10 so as to pivot about pivot axis 26. Each of conventional flail chains 19 is comprised of a plurality of interconnected links 28 that are oval in shape, as shown in more detail in FIG. 2. Other conventional flail chains may be comprised of links 30 having a circular shape, as shown in FIG. 3, or links that are generally rectangular in shape (not shown). These chain links are made of heat-treated wire or rod material having a generally circular cross-section and a diameter of 0.50-0.75 inches or larger.

The inventor has found that flail chains comprised of links, at least some of which have a polygonal cross-section, generate more tractive force as the chain strikes the bark, which improves the transfer of energy used to loosen and remove the bark. Furthermore, flail assemblies including chains comprised of links, at least some of which have a polygonal cross-section, are more efficient and can be operated at reduced speeds, thereby saving energy and reducing the maintenance required for long-term operation of the flail assembly.

### Advantages of the Invention

Among the advantages of the invention is that it provides a flail assembly and a method of flailing that is more efficient than conventional flail assemblies, and may be operated effectively at reduced speeds, when compared to conventional flail assemblies. The invention also provides a flail assembly for a debarking machine that requires less energy for efficient operation and less maintenance for long-term operation. Other advantages and features of this invention will become apparent from an examination of the drawings and the ensuing description.

### Notes on Construction

The use of the terms “a”, “an”, “the” and similar WI is in the context of describing the invention are to be construed to cover both the singular and the plural, unless otherwise indicated herein or clearly contradicted by context. The terms “comprising”, “having”, “including” and “containing” are to be construed as open-ended terms (i.e., meaning “including, but not limited to,”) unless otherwise noted. The terms “substantially”, “generally” and other words of degree are relative modifiers intended to indicate permissible variation from the characteristic so modified. The use of such terms in describing a physical or functional characteristic of the invention is not intended to limit such characteristic to the absolute value which the term modifies, but rather to provide an approximation of the value of such physical or functional characteristic.

The use of any and all examples or exemplary language (e.g., “such as” and “preferably”) herein is intended merely to better illuminate the invention and the preferred embodiments thereof, and not to place a limitation on the scope of the invention. Nothing in the specification should be construed as indicating any element as essential to the practice of the invention unless so stated with specificity.

Terms concerning attachments, coupling and the like, such as “connected”, “interconnected” and “attached”, refer to a relationship wherein structures are secured or attached to one another either directly or indirectly through intervening structures, as well as both moveable and rigid attachments or relationships, unless specified herein or clearly indicated by context. The terms “operatively connected” and “operatively attached” describe an attachment, coupling or connection that allows the pertinent structures to operate as intended by virtue of that relationship.

All methods described herein can be performed in any suitable order unless otherwise specified herein or clearly indicated by context.

Various terms are specifically defined herein. These terms are to be given their broadest reasonable construction consistent with such definitions, as follows:

The term “debarking machine” refers to a machine for removing bark and limbs from a log. A debarking machine may also include a log chipping component.

The term “flail assembly” refers to a flail shaft, which may comprise an axle, drum and bearings associated therewith, with flail chains operatively attached, that is a part of a debarking machine.

The term “processing direction” refers to the direction of travel of a log for processing through a flail assembly.

The term “flail shaft”, when used in reference to a flail assembly, comprises a shaft, axle, disk and/or drum that is rotatable about an axis of rotation and to which one or more flail chains (as hereinafter defined) are operatively attached.

The term “flail chain” refers to a chain comprised of a plurality of interconnected links and having an attachment end and a free end. The attachment end of a flail chain is operatively attached to a flail shaft that is rotated so that the free end, or a portion thereof, can come into contact with a log in a debarking machine.

The terms “chain link” and “link” refer to the links that are interconnected to form a flail chain.

The term “polygonal” refers to a closed plane shape having a plurality of linear sides, which shape may have rounded edges where the linear sides meet. Polygonal shapes include, but are not limited to, equilateral and other triangles, squares, rectangles, rhombi, regular and irregular pentagons and hexagons.

### SUMMARY OF THE INVENTION

The invention comprises a flail chain for the flail assembly of a debarking machine, and a method for operating a flail assembly comprising a plurality of such flail chains. At least some of the chain links of the flail chain of this invention have a polygonal cross-section.

In a preferred embodiment of the invention, at least some of the chain links of the flail chains have a square or rectangular cross-section. In a particularly preferred embodiment of the invention, all of the chain links of the flail chains have a square or rectangular cross-section. The preferred flail assembly includes a flail shaft that is mounted for rotation about an axis that is generally perpendicular to the processing direction in which logs are moved for debarking and generally parallel to the plane of the surface on which the debarking machine is placed. Attached to this flail shaft are a plurality of the flail chains, each of which has an attachment end that is operatively attached to the shaft, and a free end.

In order to facilitate an understanding of the invention, the preferred embodiments of the invention and the best mode known by the inventor for carrying out the invention are illustrated in the drawings, and a detailed description thereof follows. It is not intended, however, that the invention be limited to the particular embodiments described or to use in connection with the apparatus illustrated herein. Therefore, the scope of the invention contemplated by the inventor includes all equivalents of the subject matter described herein, as well as various modifications and alternative embodiments such as would ordinarily occur to one skilled in the art to which the invention relates. The inventor expects skilled artisans to employ such variations as seem to them appropriate, including the practice of the invention otherwise than as specifically described herein. In addition, any combination of the elements and components of the invention described herein in any possible variation is intended to be encompassed within the scope of the invention, unless otherwise indicated herein or clearly excluded by context.

### BRIEF DESCRIPTION OF THE DRAWINGS

FIG. 1 is a side view of a portion of a conventional debarking machine which includes an upper flail assembly and a lower flail assembly 14.

FIG. 2 is a front view of a portion of a conventional flail chain comprised of a plurality of interconnected links that are oval in shape and have a generally circular cross-section.

FIG. 3 is a front view of a portion of a conventional flail chain comprised of a plurality of interconnected links that are circular in shape and have a generally circular cross-section.

FIG. 4 is a perspective view of a portion of a flail chain comprised of links having a polygonal cross-section, and more specifically, a square cross-section.

FIG. 5 is a sectional view of a link of the flail chain shown in FIG. 4.

FIG. 6 is a sectional view of a link of a flail chain having a polygonal cross-section, and more specifically, a rectangular cross-section.

FIG. 7 is a sectional view of a link of a flail chain having a polygonal cross-section, and more specifically, a rhomboidal cross-section.

FIG. 8 is a sectional view of a link of a flail chain having a polygonal cross-section, and more specifically, a triangular cross-section.

FIG. 9 is a sectional view of a link of a flail chain having a polygonal cross-section, and more specifically, a hexagonal cross-section.

### DESCRIPTION OF THE PREFERRED EMBODIMENTS OF THE INVENTION

This description of the preferred embodiments of the invention is intended to be read in connection with the accompanying drawings, which are to be considered part of the entire written description of this invention. The drawings are not necessarily to scale, and certain features of the invention may be shown exaggerated in scale or in somewhat schematic four in the interest of clarity and conciseness.

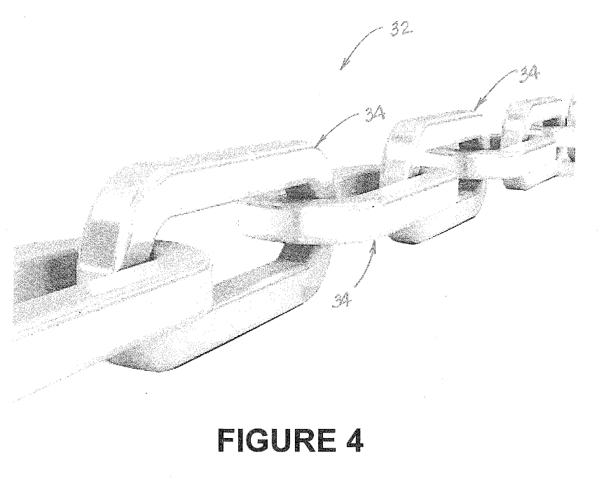

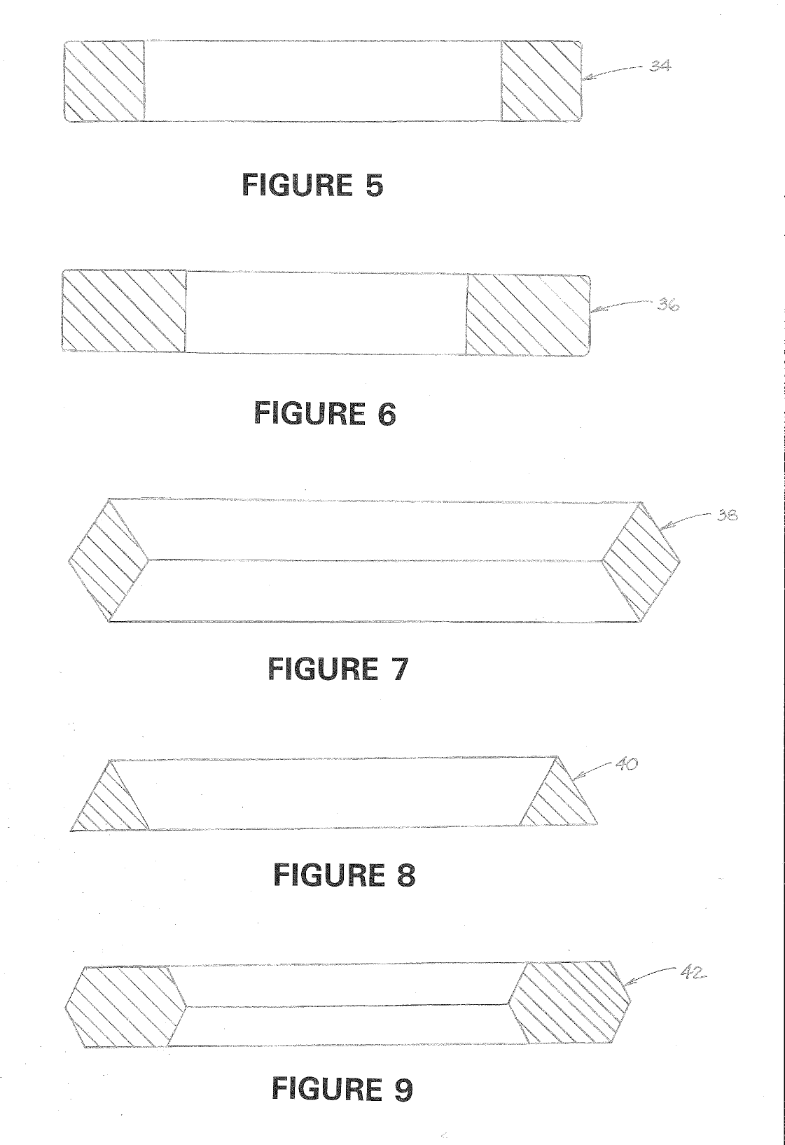

As shown in FIG. 4, flail chain 32 is comprised of a plurality of essentially identical chain links 34, each of which has a square cross-section, as shown in FIG. 5. FIG. 6 illustrates a first alternative embodiment of the chain link of the invention, comprising link 36 that has a rectangular cross-section. FIG. 7 illustrates a second alternative embodiment of the chain link of the invention, comprising link 38 having a cross-section in the shape of a rhombus. FIG. 8 illustrates a third alternative embodiment of the chain link of the invention, comprising link 40 that has a cross-section in the shape of an equilateral triangle. FIG. 9 illustrates a fourth alternative embodiment of the chain link of the invention, comprising link 42 that has a cross section in the shape of an irregular hexagon. Flail chains may be made, according to the invention, comprising a plurality of links having cross-sections of other polygonal shapes than those shown in the drawings. Such flail chain links may be oval in shape, circular in shape, rectangular in shape or of other conventional shapes.

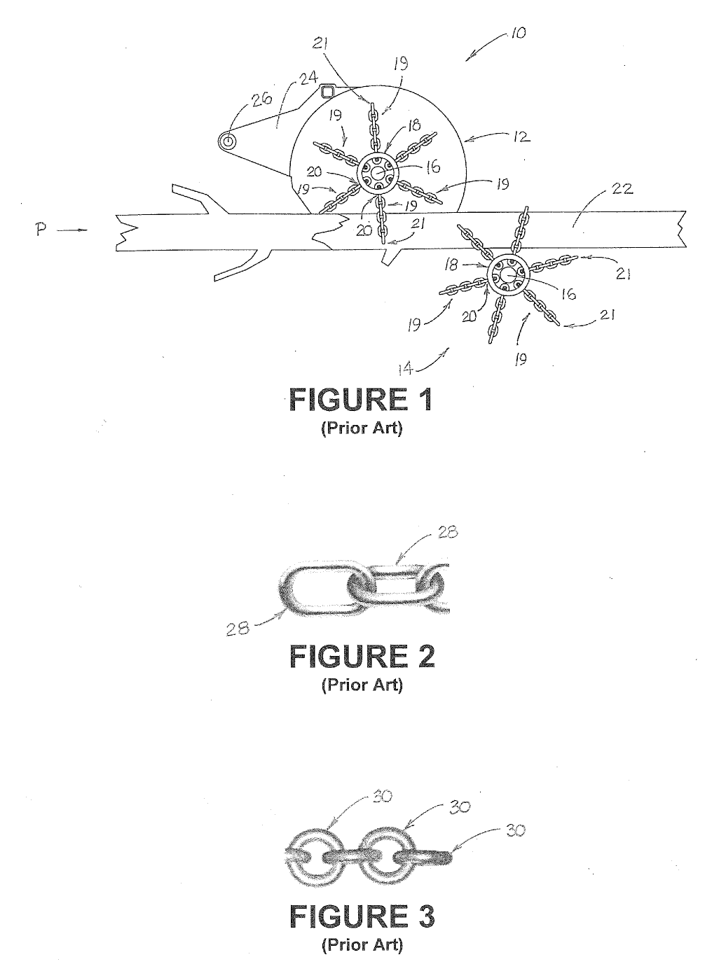

The flail chains of the invention are adapted to be employed in the flail assembly of a debarking machine that is adapted to process a log such as log 22 shown in FIG. 1, as the log is carried through the machine in processing direction P. Each of the flail assemblies includes a flail shaft to which are operatively attached a plurality of flail chains, the links of at least some of which, and preferably all of which, have a polygonal cross-section. Each flail shaft of a flail assembly is driven by a motor or other known means so as to rotate about a flail axis of rotation that is perpendicular to the plane of the page of FIG. 1. Such flail axis of rotation is generally perpendicular to the processing direction and generally parallel to the surface on which the debarking machine is placed for operation. Each flail chain has an attachment end that is attached to the flail shaft, and a free end. Rotation of the flail shafts causes the flail chains to contact the bark on the log as it is moved in processing direction P, and thereby to flail the bark and limbs from the log.

Flail chains comprised of links, at least some of which have a polygonal cross-section, generate more tractive force as the chain strikes the bark, which improves the transfer of energy used to loosen and remove the bark. Furthermore, flail assemblies including chains comprised of links, at least some of which have a polygonal cross-section, are more efficient and can be operated at reduced speeds, thereby saving energy and reducing the maintenance required for long-term operation of the flail assembly.

Although this description contains many specifics, these should not be construed as limiting the scope of the invention but as merely providing illustrations of the presently preferred embodiments thereof, as well as the best mode contemplated by the inventors of carrying out the invention. The invention, as described herein, is susceptible to various modifications and adaptations, as would be understood by those having ordinary skill in the art to which the invention relates.

What is claimed is:

1. A flail assembly for a debarking machine comprising:
(a) a flail shaft that is adapted to be rotated about a flail axis of rotation;
(b) a flail chain comprising:
(i) an attachment end that is attached to the flail shaft;
(ii) a free end;
(iii) a plurality of interconnected links, at least some of which have a polygonal cross-section, which polygonal cross-section comprises a closed plane shape having at least three linear sides, with all of such linear sides being defined by straight lines.

2. The flail assembly of claim 1 wherein the flail chain comprises a plurality of interconnected links, all of which have a polygonal cross-section comprising a closed plane shape having at least three linear sides, with all of such linear sides being defined by straight lines.

3. The flail assembly of claim 1 wherein the flail chain comprises a plurality of interconnected links, at least some of which have a cross-section in a polygonal shape that is selected from the group consisting of equilateral and other triangles, squares, rectangles, rhombi, regular and irregular pentagons and hexagons.

4. The flail assembly of claim 1 wherein the flail chain comprises a plurality of interconnected links, all of which have a cross-section in a polygonal shape that is selected from the group consisting of equilateral and other triangles, squares, rectangles, rhombi, regular and irregular pentagons and hexagons.

5. A method for removing bark from a log, said method comprising:
(a) providing a flail assembly comprising:
(i) a flail shaft that is mounted for rotation about a flail axis of rotation;
(ii) means for rotating the flail shaft about the flail axis of rotation;
(iii) a plurality of flail chains, each of which has an attachment end that is attached to the flail shaft and a free end, wherein each of said flail chains comprises a plurality of interconnected links, at least some of which have a polygonal cross-section, which polygonal cross-section comprises a closed plane shape having at least three linear sides, with all of such linear sides being defined by straight lines;
(b) moving the log in a processing direction that is generally perpendicular to the flail shaft axis so that rotation of the flail shaft will cause the flail chains to contact the log.

6. The method of claim 5 which includes providing a flail assembly having a plurality of flail chains, each of which comprises a plurality of interconnected links, all of which have a polygonal cross-section comprising a closed plane shape having at least three linear sides, with all of such linear sides being defined by straight lines.

7. The method of claim 5 which includes providing a flail assembly having a plurality of flail chains, each of which comprises a plurality of interconnected links, at least some of which have a cross-section in a polygonal shape that is selected from the group consisting of equilateral and other triangles, squares, rectangles, rhombi, regular and irregular pentagons and hexagons.

8. The method of claim 5 which includes providing a flail assembly having a plurality of flail chains, each of which comprises a plurality of interconnected links, all of which have a cross-section in a polygonal shape that is selected from the group consisting of equilateral and other triangles, squares, rectangles, rhombi, regular and irregular pentagons and hexagons.

9. The flail assembly of claim 4 wherein the flail chain comprises a plurality of interconnected links, all of which have a polygonal cross-section comprising a closed plane shape having four linear sides, with all of such linear sides being defined by straight lines.

10. The flail assembly of claim 9 wherein all of the links of the flail chain have a rectangular cross-section.

11. The flail assembly of claim 9 wherein all of the links of the flail chain have a square cross-section.
